(19) United States
(12) Patent Application Publication
(10) Pub. No.: US 2004/0246551 A1
(43) Pub. Date: Dec. 9, 2004

(54) Window

(76) Inventor: Herman Hubertus Jacobus Reijnen, (US)

Correspondence Address: Alan E Kopecki, Burns Doane Swecker & Mathis, P O Box 1404, Alexandria, VA, 22313-1404, US

(21) Appl. No.: 10/203,938

(22) PCT Filed: Feb. 1, 2001
(86) PCT No.: PCT/IB01/00119

(30) Foreign Application Priority Data
Feb. 18, 2000 (ZA) 2000/0800

(51) Int. Cl. G02B 26/08

(52) U.S. Cl. 359/212

(57) ABSTRACT

A window comprises a holder (30) having an opening for receiving a layer (44) of diamond, sapphire or like material, the opening being defined by a surface (38) which slopes from one edge (40) to an opposite edge (42) and a layer (44) of diamond, sapphire or like material having an edge surface (50) complemental with the opening-defining surface (38) located in the opening such that the complemental surfaces (38, 50) complement each other and are bonded to each other. Generally, a bonding layer (52) is provided between the complemental surfaces (38, 50).

### BACKGROUND OF THE INVENTION

This invention relates to windows and more particularly to diamond windows.

Diamond windows are used in a variety of sophisticated and high technology applications. For example, diamond windows are used as infrared windows for lasers and for process monitoring. In such applications, the diamond layer is generally mounted in a holder in a manner illustrated by FIG. 1 of the accompanying drawings. Referring to this figure, a cylindrical holder 10 has an end 12 and an opposite end 14. The end 14 has a circular recess 16 formed therein. Located in the recess 16 is a layer 18 which may be made of diamond, sapphire or similar material. The layer 18 is held in position by means of bonding layer 20 which may be glue, solder, braze or other similar bonding material. This prior art method has the disadvantage that the diamond in the region of the bonding layer 20 is not utilised. This adds to the expense of the window because diamond is an expensive material. Further, diamond has a very low coefficient of thermal expansion and stresses can build up in the bonding layer or region.

### SUMMARY OF THE INVENTION

According to a first aspect of the invention, there is provided a window comprising a holder having an opening for receiving a layer of diamond, sapphire or like material, the opening being defined by a surface which slopes from one edge to an opposite edge and a layer of diamond, sapphire or like material having an edge surface complemental with the opening-defining surface located in the opening such that the complemental surfaces complement each other and are bonded to each other.

Further according to the invention, the holder has an internal passage which communicates with the opening, an edge is defined between the internal passage and the opening and the opening-defining surface slopes outwards from this edge.

The opening may have a central axis passing therethrough. Generally the opening-defining surface defines an angle of no more than 10° with the axis.

Bonding between the layer and the holder may be achieved mechanically, e.g. a force fit, but is preferably achieved by use of a layer of bonding material provided between the complemental surfaces. The bonding material may be glue, metal, solder, braze or similar material.

It is preferred that the opening-defining surface exerts a compressive force on the complemental surface of the layer.

According to another aspect of the invention, a method of producing a window as described above includes the steps of providing a holder having an opening, the opening being defined by a surface which slopes from one edge to an opposite edge, providing a layer of diamond, sapphire or like material having an edge surface complemental with the opening-defining surface of the holder, providing at least one of the complemental surfaces with a layer of bonding material, introducing the layer into the opening such that the complemental surfaces complement each other, and causing the layer of bonding material to bond the complemental surfaces to each other.

It is preferred that the holder is metallic and the bonding layer is a braze or solder or a metal, particularly in the case of thermal compression bonding. Bonding may be achieved by heating the braze, solder or the layer of metal. If the layer is of a material such as diamond having a low coefficient of thermal expansion, then on creating the bond the opening will decrease in size on cooling resulting in the holder exerting a compressive force on the layer located therein. An example of a particularly suitable layer of metal for thermal compression bonding is gold.

The invention has particular application to windows in which the layer and the opening in which it is located are both of truncated cone shape.

### BRIEF DESCRIPTION OF THE DRAWINGS

FIG. 1 is a sectional side view of a window of the prior art, and

FIG. 2 is a sectional side view of an embodiment of a window of the invention.

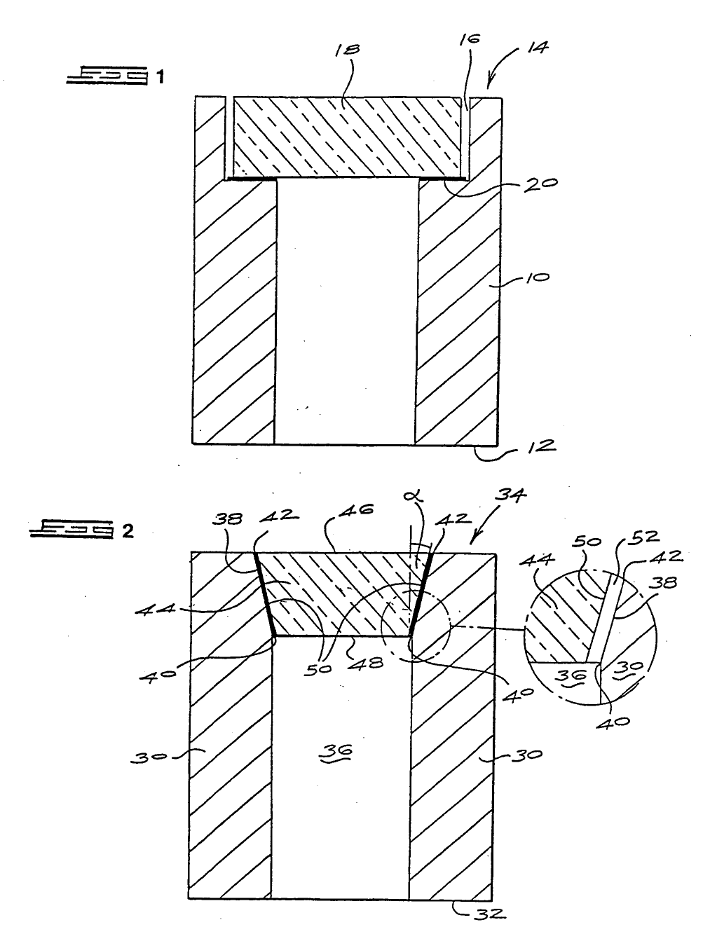

### DESCRIPTION OF EMBODIMENTS

An embodiment of the invention will now be described with reference to FIG. 2 of the accompanying drawings. Referring to this figure, a diamond window comprises a cylindrical holder 30 having ends 32 and 34. The end 34 has an opening formed therein. The opening is defined by a surface 38 which slopes outward from an inner edge 40 to an outer edge 42. The opening thus is of truncated cone shape. Located in the opening is a diamond layer 44 which has an outer surface 46 and an inner surface 48. The outer surface 46 and the inner surface 48 are joined by a sloping peripheral surface 50 which complements the opening-defining surface 38. The diamond layer 44 is also of truncated cone shape. The layer 44 is bonded to the holder 30 by means of a bonding layer 52.

In one example of the invention, the holder is made of steel. A layer of gold is deposited on the surface 38 and a layer of gold is deposited on the surface 50 of the diamond layer 44. The temperature is raised to a bonding temperature, typically 500° C. The thus coated diamond layer 44 is pushed into the opening of the holder such that the two layers of gold come into firm contact with each other. On cooling, the opening in the end 34 shrinks or reduces in size resulting in the holder exerting a compressive force on the diamond layer 44. A firm and effective bond between diamond layer and holder is achieved.

The angle α which the surfaces 38, 50 make with the vertical axis passing through the opening in the illustrated embodiment is 7°. This angle can be up to 40°, but is typically no more than 100.

The diamond window illustrated in the embodiment of FIG. 2 can be used in a variety of applications including applications which experience high temperature, high vacuum or high pressure, or applications which require a high degree of cleanness or chemical inertness. The diamond window has several advantages over the prior art windows such as a minimum wastage of diamond, a substantially reduced tensile strength in the diamond, and a substantially reduced shear strength at the joint between the diamond and holder.

It is well known that chemical vapour deposited diamond can have a higher tensile strength at the nucleation side than at the end growth side. In this case, a preferred mounting configuration would be to have the nucleation side in the mounted window where a higher tensile strength is encountered. Most often this is the outer surface 46 of the mounted window.

1. A window comprising a holder having an opening for receiving a layer of diamond, sapphire, or like material, the opening being defined by a surface which slopes from one edge to an opposite edge and a layer of diamond, sapphire or like material having an edge surface complemental with the opening-defining surface located in the opening such that the complemental surfaces complement each other and are bonded to each other.

2. A holder according to claim 1 which has an internal passage which communicates with the opening, an edge defined between the passage and the opening and the opening-defining surface sloping outwards from the edge.

3. A holder according to claim 1 or claim 2 wherein the opening has a central axis passing therethrough and the opening-defining surface defines an angle of no more than 10° with the axis.

4. A holder according to any one of the preceding claims wherein a layer of bonding material is provided between the complemental surfaces.

5. A holder according to claim 4 wherein the bonding material is glue, solder, braze, metal or similar material.

6. A holder according to claim 5 wherein the bonding material is gold.

7. A holder according to any one of the preceding claims wherein the layer and the opening in the holder are both of truncated cone shape.

8. A holder according to any one of the preceding claims wherein the opening-defining surface exerts a compressive force on the complemental surface of the layer.

9. A method of producing a window according to any one of the preceding claims which includes the steps of providing a holder having an opening defined by a surface which slopes from one edge to an opposite edge, providing a layer of diamond, sapphire or like material having an edge surface complemental with an opening-defining surface of the holder, providing at least one of the complemental surfaces with a layer of bonding material, introducing the layer into the opening such that the complemental surfaces complement each other, and causing the layer of bonding material to bond the complemental surfaces to each other.

10. A method according to claim 9 wherein the holder is metallic and the bonding layer is a braze, solder or a metal.

11. A method according to claim 9 or claim 10 wherein the layer is a diamond layer.

12. A method according to any one of claims 9 to 11 wherein the bonding layer is gold.

13. A method according to any one of claims 9 to 12 wherein the layer of bonding material is caused to bond the complemental surfaces to each other by heating the holder and layer.

14. A method according to claim 13 wherein heating is such as to cause the bonding material to melt.

15. A window substantially as herein described with reference to FIG. 2 of the accompanying drawings.

16. A method of preducing a window substantially as herein described with reference to FIG. 2 of the accompanying drawings.
